(19) United States
(12) Patent Application Publication
(10) Pub. No.: US 2025/0337868 A1
(43) Pub. Date: Oct. 30, 2025

(54) DISPLAY CONTROL METHOD, DISPLAY CONTROL PROGRAM, AND PROJECTOR

(71) Applicant: SEIKO EPSON CORPORATION, Tokyo (JP)

(72) Inventor: Hiroyuki ICHIEDA, MATSUMOTO-SHI (JP)

(21) Appl. No.: 19/188,603

(22) Filed: Apr. 24, 2025

(30) Foreign Application Priority Data
Apr. 25, 2024 (JP) 2024-071245

(51) Int. Cl. H04N 9/31; G09G 3/00

(52) U.S. Cl. CPC H04N 9/3188; G09G 3/002; H04N 9/3182; H04N 9/3194; G09G 2320/0626; G09G 2320/0666; G09G 2320/103; G09G 2340/0407; G09G 2340/045; G09G 2354/00

(57) ABSTRACT

A display control method includes causing a projector to project and display a first pattern image on a screen; causing a camera to capture an image of the first pattern image to acquire a captured image; identifying a first region that is a region that fails to be normally detected out of the first pattern image based on the captured image; and causing the projector to display a second pattern image that is the first pattern image so processed that the first region is distinguishable from a second region that is a region excluding the first region out of the first pattern image.

The present application is based on, and claims priority from JP Application Serial Number 2024-071245, filed Apr. 25, 2024, the disclosure of which is hereby incorporated by reference herein in its entirety.

### BACKGROUND

### 1. Technical Field

The present disclosure relates to a display control method, a display control program, and a projector.

### 2. Related Art

JP-A-2024-018681 discloses a pattern image detecting method including causing a projector to display a first pattern image, acquiring a first captured image produced by capturing an image of the first pattern image with a camera, performing the process of detecting a second pattern image corresponding to the first pattern image from the first captured image, performing a first correction process of increasing the possibility of successful detection of the second pattern image on the first captured image to acquire a second captured image when the detection of the second pattern image from the first captured image fails, and performing the process of detecting the second pattern image from the second captured image.

JP-A-2024-018681 is an example of the related art.

In JP-A-2024-018681, for example, when the first pattern image is a dot pattern image containing multiple dot images, and when the detection of the second pattern image from the first captured image fails, which dot image has been unsuccessfully detected cannot be grasped. A user's request to grasp which dot image has been unsuccessfully detected cannot therefore be met.

### SUMMARY

An aspect of the present disclosure relates to a display control method including causing a projector to project a first pattern image onto a projection surface; causing a camera to capture an image of the first pattern image to acquire a captured image; identifying a first region that is a region that fails to be normally detected out of the first pattern image based on the captured image; and causing a display apparatus including the projector to display a second pattern image that is the first pattern image so processed that the first region is distinguishable from a second region that is a region excluding the first region out of the first pattern image.

Another aspect of the present disclosure relates to a display control program causing a computer to carry out processes including causing a projector to project a first pattern image onto a projection surface; causing a camera to capture an image of the first pattern image to acquire a captured image; identifying a first region that is a region that fails to be normally detected out of the first pattern image based on the captured image; and causing a display apparatus including the projector to display a second pattern image that is the first pattern image so processed that the first region is distinguishable from a second region that is a region excluding the first region out of the first pattern image.

Still another aspect of the present disclosure relates to a projector configured to project a first pattern image onto a projection surface; cause a camera to capture an image of the first pattern image to acquire a captured image; identify a first region that is a region that fails to be normally detected out of the first pattern image based on the captured image; and project and display a second pattern image on the projection surface, the second pattern image being the first pattern image so processed that the first region is distinguishable from a second region that is a region excluding the first region out of the first pattern image.

### BRIEF DESCRIPTION OF THE DRAWINGS

FIG. 1 shows an example of the configuration of a projector according to an embodiment of the present disclosure.

FIG. 2 shows an example of the configuration of a controller of the projector.

FIG. 3 shows an example of a first pattern image.

FIG. 4 shows an example of a second pattern image.

FIG. 5 is a flowchart showing an example of processes carried out by the controller.

### DESCRIPTION OF EMBODIMENTS

An embodiment of the present disclosure will be described below with reference to the drawings.

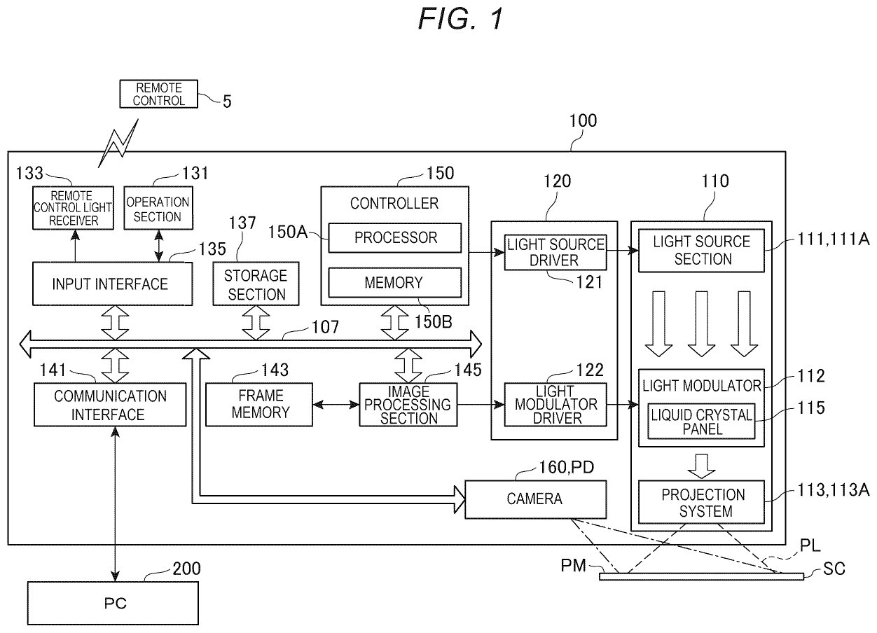

The configuration of a projector 100 will first be described with reference to FIG. 1. FIG. 1 shows an example of the configuration of the projector 100.

The projector 100 includes a projection unit 110 and a driver unit 120, which drives the projection unit 110, as shown in FIG. 1.

The projection unit 110 forms an optical image and projects image light PL corresponding to a projection image PM onto a screen SC. The projection unit 110 projects the image light PL to display the projection image PM on the screen SC.

The screen SC corresponds to an example of a “projection surface”.

The present embodiment will be described with reference to, but not limited to, the case where the “projection surface” is the screen SC. The “projection surface” may instead, for example, be a building, a castle, or any other building. The “projection surface” may still instead be a three-dimensional object other than a building, a planar surface, or a portion of the entirety of an object.

The projection unit 110 includes a light source section 111, a light modulator 112, and a projection system 113. The driver unit 120 includes a light source driver 121 and a light modulator driver 122.

The light source section 111 includes a solid-state light source 111A such as a light emitting diode (LED) or a laser light source.

The present embodiment will be described with reference to, but not limited to, the case where the light source section 111 includes the solid-state light source 111A. The light source section 111 may include a lamp light source such as a halogen lamp, a xenon lamp, or an ultrahigh-pressure mercury lamp in place of the solid-state light source 111A.

The solid-state light source 111A is referred to as a light source 111A in some cases in the following description.

The light source section 111 may include a reflector and an auxiliary reflector that guide light output from the light source 111A to the light modulator 112. The light source section 111 may further include a lens group that improves the optical characteristics of projection light, a polarizer, an attenuator that reduces the amount of the light output by the light source 111A in the path leading to the light modulator 112, or any other element.

The light source driver 121 is coupled to an internal bus 107, and turns on and off the light source 111A of the light source section 111 in accordance with an instruction from a controller 150 also coupled to the internal bus 107 to control the output from the light source 111A.

The light modulator 112 includes, for example, three liquid crystal panels 115 corresponding to the three primary colors, R, G, and B. R represents red, G represents green, and B represents blue. That is, the light modulator 112 includes the liquid crystal panel 115 corresponding to R color light, the liquid crystal panel 115 corresponding to G color light, and the liquid crystal panel 115 corresponding to B color light.

The light output from the light source section 111 is separated into the three types of color light RGB, which enter the corresponding liquid crystal panels 115. The three liquid crystal panels 115 are each a transmissive liquid crystal panel and modulate the light passing therethrough to generate the image light PL. The multiple types of image light PL having passed through and having been modulated by the liquid crystal panels 115 are combined with one another by a light combining system such as a cross dichroic prism, and the combined image light PL is output to the projection system 113.

The present embodiment will be described with reference to, but not limited to, the case where the light modulator 112 includes the transmissive liquid crystal panels 115 as light modulating devices. The light modulating devices may each be a reflective liquid crystal panel or a digital micromirror device.

The light modulator 112 is driven by the light modulator driver 122. The light modulator driver 122 is coupled to an image processing section 145.

Image data corresponding to the primary colors, R, G, and B, are input from the image processing section 145 to the light modulator driver 122. The light modulator driver 122 converts the input image data into a data signal suitable for the operation of the liquid crystal panels 115. The light modulator driver 122 applies a voltage to each pixel of each of the liquid crystal panels 115 based on the data signal, into which the image data has been converted, to draw an image at the liquid crystal panel 115.

The projection system 113 includes a projection lens 113A, a mirror, and other elements that cause the incident image light PL to form an image on the screen SC. The projection system 113 further includes a zoom mechanism that enlarges or reduces an image projected onto the screen SC, a focus adjustment mechanism that adjusts focusing, and a lens shift mechanism that adjusts the direction in which the image light PL is projected.

The projector 100 further includes a camera 160.

The camera 160 includes an imaging device such as a charge coupled device (CCD) or a complementary metal oxide semiconductor (CMOS) device.

The camera 160 captures an image of the screen SC and generates a captured image PD in accordance with an instruction from the controller 150. The controller 150 causes the camera 160 to generate the captured image PD. The camera 160 delivers the generated captured image PD to the controller 150. The controller 150 transmits the captured image PD to a personal computer 200. The captured image PD contains the projection image PM.

The camera 160 is disposed, for example, in the vicinity of the projection lens 113A of the projector 100.

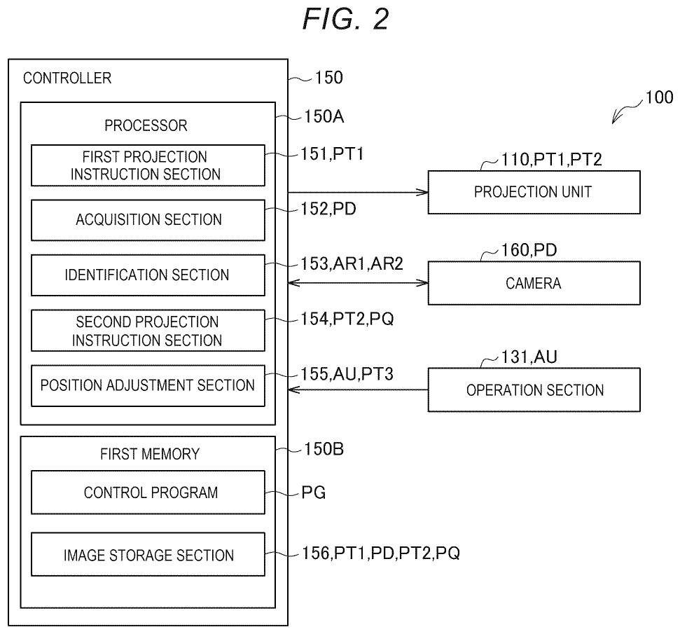

The camera 160 will be further described with reference to FIG. 2.

The projector 100 further includes an operation section 131, a remote control light receiver 133, an input interface 135, a storage section 137, a communication interface 141, a frame memory 143, the image processing section 145, and the controller 150. The input interface 135, the storage section 137, the communication interface 141, the image processing section 145, the controller 150, and the camera 160 are coupled to each other via the internal bus 107 so as to be capable of data communication.

The operation section 131 includes various buttons and switches provided at a surface of an enclosure of the projector 100, generates an operation signal corresponding to an operation of any of the buttons and switches, and outputs the generated operation signal to the input interface 135. The input interface 135 includes a circuit that outputs the operation signal input by the user via the operation section 131 to the controller 150.

The remote control light receiver 133 receives an infrared signal transmitted from a remote control 5 and decodes the received infrared signal to generate an operation signal. The remote control light receiver 133 outputs the generated operation signal to the input interface 135. The input interface 135 includes a circuit that outputs the operation signal input from the remote control light receiver 133 to the controller 150.

The storage section 137 is, for example, a magnetic recording apparatus such as a hard disk drive (HDD), or a storage apparatus using a semiconductor storage device such as a flash memory or a solid-state drive (SSD). The storage section 137 stores a program executed by the controller 150, data processed by the controller 150, image data, and other pieces of information.

The communication interface 141 is a communication interface that performs communication with the personal computer 200 in compliance, for example, with the USB (universal serial bus) (registered trademark) standard. The communication interface 141 includes a connector that couples a USB (registered trademark) cable, and an interface circuit that processes a signal delivered via the connector. The communication interface 141 is an interface substrate including the connector and the interface circuit, and is coupled to a primary substrate at which a processor 150A of the controller 150 and other elements are implemented. The connector and the interface circuit the communication interface 141 are instead implemented at the primary substrate of the controller 150. The communication interface 141 transmits, for example, the captured image PD to the personal computer 200.

Note that the communication interface 141 may be a communication interface that performs communication with the personal computer 200 via a local area network (LAN) or a wireless local area network (WLAN).

The controller 150 includes a memory 150B and the processor 150A.

The memory 150B is a storage apparatus that stores a program executed by the processor 150A and data processed by the processor 150A in a nonvolatile manner. The memory 150B is configured with a magnetic storage apparatus, a semiconductor storage device such as a flash read only memory (ROM), or a nonvolatile storage apparatus of a type different from the above. The memory 150B may also include a random access memory (RAM) that constitutes a work area of the processor 150A. The memory 150B stores data processed by the controller 150, a control program PG executed by the processor 150A, pieces of information.

The processor 150A may be configured with a single processor, or multiple processors may be configured to function as the processor 150A. The processor 150A executes the control program PG to control each section of the projector 100. For example, the processor 150A outputs instructions to perform image processing corresponding to operations received by the operation section 131 and the remote control 5, and parameters used in the image processing to the i image processing section 145. The parameters include, for example, a geometric correction parameter used to correct geometric distortion of an image to be projected onto the screen SC. The processor 150A controls the light source driver 121 to turn on and off the light source section 111, and adjust the output, that is, the amount of the light from the light source section 111.

The processor 150A may be configured with a system-on-a-chip (SoC) in which the processor 150A is integrated with a portion or the entirety of the memory 150B and other circuits. The processor 150A may be configured with a combination of a central processing unit (CPU) that executes a program and a digital signal processor (DSP) that performs predetermined arithmetic processing. All the functions of the processor 150A may be implemented in the form of hardware or by using a programmable device.

The image processing section 145 and the frame memory 143 can be configured, for example, with an integrated circuit. The integrated circuit includes a large-scale integration (LSI) circuit, an application specific integrated circuit (ASIC), and a programmable logic device (PLD). The PLD includes, for example, a field-programmable gate array (FPGA). A portion of the configuration of the integrated circuit may include an analog circuit, or a combination of a processor and the integrated circuit may be employed. The combination of a processor and the integrated circuit is called a microcontroller (MCU), an SoC, a system LSI, a chipset, or the like.

The image processing section 145 develops image data corresponding to the projection image PM in the frame memory 143. The frame memory 143 includes multiple banks. The banks each have a storage capacity that allows image data corresponding to one frame to be written to the bank. The frame memory 143 is configured, for example, with a synchronous dynamic random access memory (SDRAM).

The image processing section 145 performs image processing, for example, resolution conversion or resizing, distortion correction, shape correction, digital zooming, and adjustment of the color tone and brightness of an image, on the image data developed in the frame memory 143.

Furthermore, the image processing section 145 converts an input frame frequency indicated by the vertical sync signal into a drawing frequency and generates a vertical sync signal indicating the drawing frequency. The generated vertical sync signal is referred to as an output sync signal. The image processing section 145 outputs the generated output sync signal to the light modulator driver 122.

The configuration of the controller 150 will next be described with reference to FIG. 2. FIG. 2 shows an example of the configuration of the controller 150 of the projector 100.

The present embodiment will be described with reference to a case where the processor 150A of the controller 150 controls each section of the projector 100 by reading and executing the control program PG from the memory 150B.

The controller 150 corresponds to an example of a “computer”.

The control program PG corresponds to an example of a “display control program”.

The controller 150 includes a first projection instruction section 151, an acquisition section 152, an identification section 153, a second projection instruction section 154, a position adjustment section 155, and an image storage section 156.

Specifically, the processor 150A executes the control program PG to function as the first projection instruction section 151, the acquisition section 152, the identification section 153, the second projection instruction section 154, and the position adjustment section 155. Furthermore, the processor 150A executes the control program PG to cause the memory 150B to function as the image storage section 156.

The image storage section 156 stores a first pattern image PT1, the captured image PD, a second pattern image PT2, an inquiry image PQ, and a third pattern image PT3.

The first pattern image PT1 is a pattern image stored in the image storage section 156 in advance. The first pattern image PT1 is, for example, a pattern image containing multiple dot images DT arranged at equal intervals. In the first pattern image PT1, the color of the background image of the multiple dot images DT is, for example, white. The first pattern image PT1 corresponds to an example of the projection image PM. Note that the first pattern image PT1 is an image used to adjust the projection image PM to be displayed on the screen SC by the projector 100. The dot images DT are each a portion of the first pattern image PT1.

The dot images DT are each a circular image having a specific color CP. The specific color CP is, for example, blue. The specific color CP may be green or red.

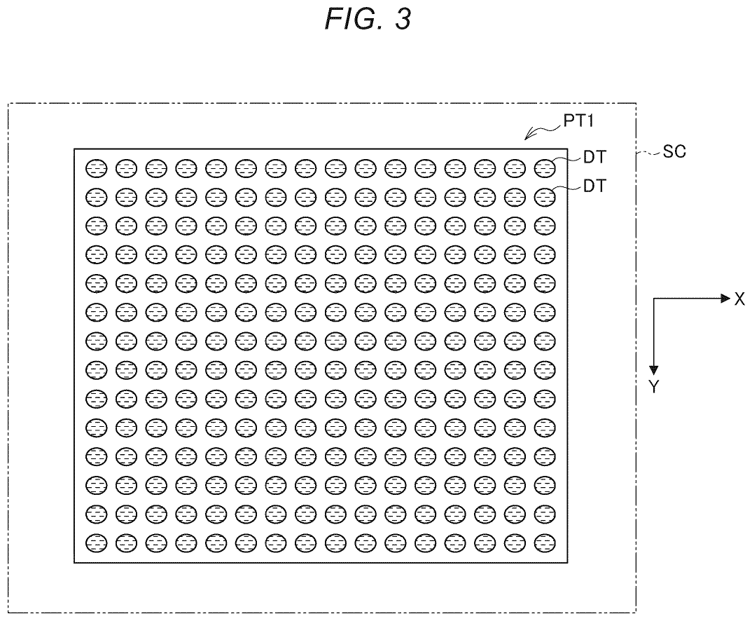

The first pattern image PT1 will be further described with reference to FIG. 3.

Note that the control program PG may generate at least one of the first pattern image PT1, the second pattern image PT2, and the third pattern image PT3 whenever necessary.

The captured image PD is acquired from the camera 160 by the acquisition section 152 and stored in the image storage section 156 by the acquisition section 152.

The second pattern image PT2 is generated by the identification section 153 based on the first pattern image PT1 and the captured image PD. The second pattern image PT2 is stored in the image storage section 156 by the identification section 153. The second pattern image PT2 corresponds to an example of the projection image PM.

The inquiry image PQ is an image that inquires of the user whether to adjust the position of the first pattern image PT1 contained in a first region AR1 based on the user's operation. The inquiry image PQ is stored in the image storage section 156 in advance. The inquiry image PQ is contained in the second pattern image PT2. The first region AR1 is identified by the identification section 153.

The third pattern image PT3 is generated by the position adjustment section 155 and stored in the image storage section 156 by the position adjustment section 155. The third pattern image PT3 corresponds to an example of the projection image PM.

The first projection instruction section 151 projects and displays the first pattern image PT1 on the screen SC. For example, the first projection instruction section 151 first reads the first pattern image PT1 from the image storage section 156. The first projection instruction section 151 then causes the projection unit 110 to project and display the first pattern image PT1 on the screen SC.

The acquisition section 152 acquires the captured image PD by causing the camera 160 to capture an image of the first pattern image PT1 projected onto the screen SC. For example, the acquisition section 152 first causes the camera 160 to capture an image of the first pattern image PT1 projected onto the screen SC. The camera 160 captures an image of the first pattern image PT1 to generate the captured image PD. The acquisition section 152 then acquires the captured image PD from the camera 160.

The identification section 153 identifies the first region AR1, which is a region that fails to be normally detected, out of the first pattern image PT1 based on the captured image PD. The “region that fails to be normally detected” is a region containing a dot image DT that fails to be normally detected in the captured image PD out of the multiple dot images DT constituting the first pattern image PT1.

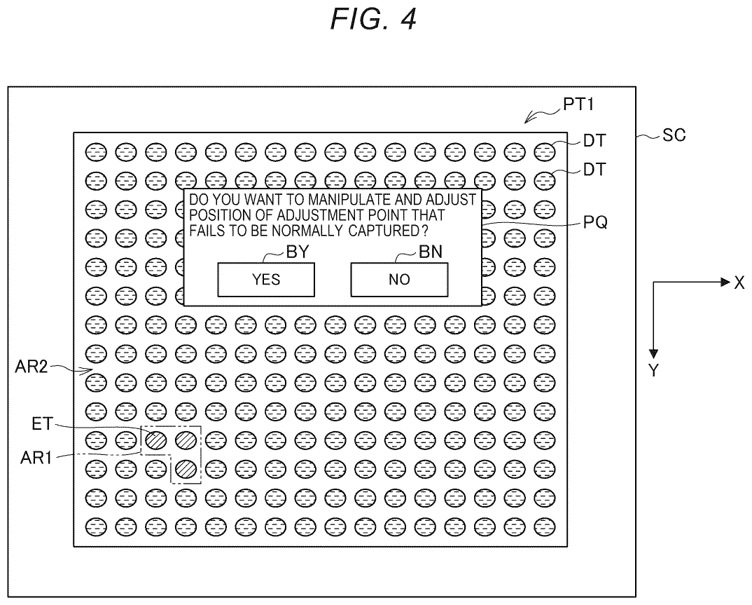

The first region AR1 will be further described with reference to FIG. 4.

The identification section 153 detects the dot image DT that fails to be normally detected. The dot image DT that fails to be normally detected is detected based, for example, on at least one of the contrast, position, size, shape, luminance, and color of each of the multiple dot images DT contained in the captured image PD. The identification section 153 identifies, for example, a dot image DT having luminance lower than a threshold out of the multiple dot images DT contained in the captured image PD as the dot image DT that fails to be normally detected.

The reason why the dot image DT that fails to be normally detected is generated in the captured image PD will next be described below.

First, the dot image DT that fails to be normally detected is generated due to an effect of external light. For example, when the ambient light at the place where the screen SC is installed is bright, the dot image DT that fails to be normally detected is generated. Instead, for example, when spot light is incident on the screen SC, the dot image DT that fails to be normally detected is generated. Still instead, when external light, for example, from a fluorescent light is incident on the screen SC, the dot image DT that fails to be normally detected is generated.

Also, due to an effect of the screen SC, the dot image DT that fails to be normally detected is generated. For example, when the curvature of the screen SC is greater than a predetermined value, in other words, when the radius of curvature of the screen SC is smaller than a predetermined value, the dot image DT that fails to be normally detected is generated. Furthermore, when the unevenness of the screen SC is greater than a predetermined value, the dot image DT that fails to be normally detected is generated.

The identification section 153 generates the second pattern image PT2, which is the first pattern image PT1 so processed that the first region AR1 out of the first pattern image PT1 can be distinguished from a second region AR2, which is a region other than the first region AR1 out of the first pattern image PT1.

For example, the identification section 153 generates a dot image DT contained in the first region AR1 out of the second pattern image PT2 and colored in a first color C1. The identification section 153 further generates dot images DT contained in the second region AR2 out of the second pattern image PT2 and colored in a second color C2 different from the first color C1.

The second color C2 is, for example, the same as the specific color CP, which is the color of the dot images DT constituting the first pattern image PT1. In the present embodiment, the second color C2 is, for example, blue. The first color C1 is, for example, red.

The present embodiment will be described with reference to, but not limited to, the case where the identification section 153 generates the dot image DT contained in the first region AR1 and colored in the first color C1 and generates the dot images DT contained in the second region AR2 and colored in the second color C2.

The identification section 153 may generate the dot image DT contained in the first region AR1 in a display mode according to a cause of the normal detection failure. When the cause due to which the dot image DT that fails to be normally detected is generated in the captured image PD is, for example, the effect of external light, the dot image DT contained in the first region AR1 is generated in the first color C1. When the cause due to which the dot image DT that fails to be normally detected is generated in the captured image PD is, for example, the effect of the screen SC, the dot image DT contained in the first region AR1 is generated in a third color C3 different from the first color C1 and the second color C2. The third color C3 is, for example, green.

In this case, the user can grasp the cause due to which the dot image DT that fails to be normally detected is generated in the captured image PD.

The identification section 153 causes the second pattern image PT2 to contain the inquiry image PQ. For example, the identification section 153 combines the second pattern image PT2 with the inquiry image PQ, and sets the combined image as the second pattern image PT2. The identification section 153 then causes the image storage section 156 to store the second pattern image PT2.

It is preferable that the inquiry image PQ is disposed in the second region AR2 out of the second pattern image PT2. In this case, when the second pattern image PT2 is displayed on the screen SC by the second projection instruction section 154, the user can visually recognize the dot image DT contained in the first region AR1.

The second projection instruction section 154 projects and displays the second pattern image PT2 generated by the identification section 153 on the screen SC. For example, the second projection instruction section 154 first reads the second pattern image PT2 from the image storage section 156. The second projection instruction section 154 then causes the projection unit 110 to project and display the second pattern image PT2 on the screen SC.

The projector 100 corresponds to an example of a “display apparatus”.

The position adjustment section 155 calculates the geometric correction parameter based on the captured image PD, which is the result of capture of an image of the first pattern image PT1 or the second pattern image PT2, and outputs the geometric correction parameter to the image processing section 145. Note that the image processing section 145 generates corrected image data representing a corrected image that is not shown but is the first pattern image PT1 or the second pattern image PT2 on which geometric correction has been performed based on the geometric correction parameter. The corrected image contains, for example, cross marks the number of which is equal to the number of the dot images DT contained in the first pattern image PT1 or the second pattern image PT2. Specifically, the corrected image contains at least one cross mark corresponding to at least one dot image DT contained in the first region AR1 and at least one cross mark corresponding to at least one of the dot images DT contained in the second region AR2. The center position of each of the cross marks coincides with the center position of the corresponding dot image DT.

When accepting an answer AU from the operation section 131, the position adjustment section 155 described above adjusts the positions of the cross marks corresponding to the first pattern image PT1 contained in the first region AR1 in accordance with the user's operation. The answer AU indicates that the position of the first pattern image PT1 contained in the first region AR1 is adjusted based on the user's operation. The first pattern image PT1 contained in the first region AR1 is the dot image DT contained in the first region AR1 in the first pattern image PT1. The user can therefore manually perform the geometric correction on the first region AR1 on which the geometric correction has not been performed due to the dot image DT that fails to be normally detected.

The cross marks correspond to an example of the “adjustment point”.

When the first pattern image PT1 contains multiple dot images DT contained in the first region AR1, the position adjustment section 155 accepts the operation of selecting a cross mark corresponding to any one of the multiple dot images DT contained in the first region AR1. The position adjustment t section 155 then accepts the operation of adjusting the position of the selected one cross mark. In other words, the position adjustment section 155 moves the position of the selected one cross mark in the direction corresponding to the user's operation by a distance corresponding to the user's operation.

Repeatedly accepting the operation of selecting a dot image DT and the operation of adjusting the position of the selected dot image DT described above allows adjustment of all the positions of the multiple dot images DT contained in the first region AR1.

When all the positions of the multiple cross marks corresponding to the multiple dot images DT contained in the first region AR1 are adjusted, the image storage section 156 is caused to store the pattern image generated after the adjustment as the third pattern image PT3. Note that the display mode of the cross marks corresponding to the dot images DT contained in the first region AR1 preferably differs from the display mode of the cross marks corresponding to the dot images DT contained in the second region AR2. The user can thus readily grasp the position of a cross mark that should be manually adjusted.

The present embodiment will be described with reference to, but not limited to, the case where the position adjustment section 155 adjusts the positions of the cross marks corresponding to the dot images DT contained in the first region AR1 in accordance with the user's operation when the answer AU is accepted from the operation section 131. Note that the answer AU indicates that the positions of the cross marks corresponding to the dot images DT contained in the first region AR1 are adjusted based on the user's operation.

For example, when the dot images DT contained in the first region AR1 satisfy a predetermined condition, the position adjustment section 155 may adjust the positions of the cross marks corresponding to the dot images DT contained in the first region AR1 in accordance with the user's operation. The predetermined condition is, for example, that the ratio of the dot images DT contained in the first region AR1 to the dot images DT contained in the first pattern image PT1 is smaller than or equal to a threshold TH set in advance. The threshold TH is, for example, 10%. The ratio of the dot images DT contained in the first region AR1 to the dot images DT contained in the first pattern image PT1 is, for example, the ratio of the number of the dot images DT contained in the first region AR1 to the number of the dot images DT contained in the first pattern image PT1. When there are a large number of cross marks to be manually adjusted by the user, the advantage provided by the geometric correction made by the manual adjustment may be overcome by the labor required for the manual adjustment. Setting the predetermined condition described above by way of example therefore reduces an increase in the labor required for the manual adjustment to improve usability.

The first pattern image PT1 will next be described with reference to FIG. 3. FIG. 3 shows an example of the first pattern image PT1.

The first pattern image PT1 is a pattern image containing multiple dot images DT arranged at equal intervals, as shown in FIG. 3. The multiple dot images DT are each a blue circular image. In FIG. 3, a description will be made with reference to a case where the first pattern image PT1 is adequately displayed at the screen SC for convenience. In FIG. 3, the blue dot images DT are lightly hatched.

FIG. 3 shows an X-axis and a Y-axis orthogonal to each other. The X-axis is a direction parallel to the direction of the long sides of the screen SC, and is, for example, the rightward-leftward direction of the screen SC. The Y-axis is a direction parallel to the direction of the short sides of the screen SC, and is, for example, the upward-downward direction of the screen SC. The positive direction of the X-axis indicates the rightward direction. The positive direction of the Y-axis indicates the downward direction.

In the first pattern image PT1, the dot images DT are arranged at equal intervals in the X-axis and Y-axis directions, as shown in FIG. 3. In the first pattern image PT1, the dot images DT are, for example, so arranged that 16 dot images DT are arranged in the X-axis direction. Furthermore, in the first pattern image PT1, the dot images DT are, for example, so arranged that 14 dot images DT are arranged in the Y-axis direction.

The second pattern image PT2 will next be described with reference to FIG. 4. FIG. 4 shows an example of the second pattern image PT2.

The second pattern image PT2 contains the first region AR1 and the second region AR2, as shown in FIG. 4. The first region AR1 is the region where the dot images DT fail to be normally detected out of the first pattern image PT1. The second region AR2 is the region where the dot images DT are normally detected out of the first pattern image PT1. In other words, the second region AR2 is the region excluding the first region AR1 out of the first pattern image PT1.

In FIG. 4, three dot images DT are contained in the first region AR1. The identification section 153 generates the dot images DT contained in the first region AR1 out of the second pattern image PT2 and colored in red. Red corresponds to an example of the first color C1.

The identification section 153 generates the dot images DT contained in the second region AR2 out of the second pattern image PT2 and colored in blue. Blue corresponds to an example of the second color C2.

In FIG. 4, the blue dot images DT are lightly hatched, and the red dot images DT are densely hatched.

The second pattern image PT2 further contains the inquiry image PQ in the second region AR2. The inquiry image PQ contains, for example, a character image showing an inquiry made to the user, “Do you want to manipulate and adjust the position of an adjustment point that was not normally geometrically corrected?” The inquiry image PQ further contains a YES button BY for accepting an input in response to the inquiry, and a NO button BN.

When the user performs the operation of selecting the YES button BY, for example, when a specific key disposed at the operation section 131 is pressed, the position adjustment section 155 adjusts the positions of the cross marks corresponding to the dot images DT contained in the first region AR1 in accordance with the user's operation. The operation of selecting the YES button BY corresponds to an example of the answer AU. The answer AU indicates that the positions of the cross marks corresponding to the dot images DT contained in the first region AR1 are adjusted based on the user's operation.

When the user performs the operation of selecting the NO button BN, for example, when another specific key disposed at the operation section 131 is pressed, the position adjustment section 155 does not perform the process of adjusting the positions of the cross marks corresponding to the dot images DT contained in the first region AR1 in accordance with the user's operation.

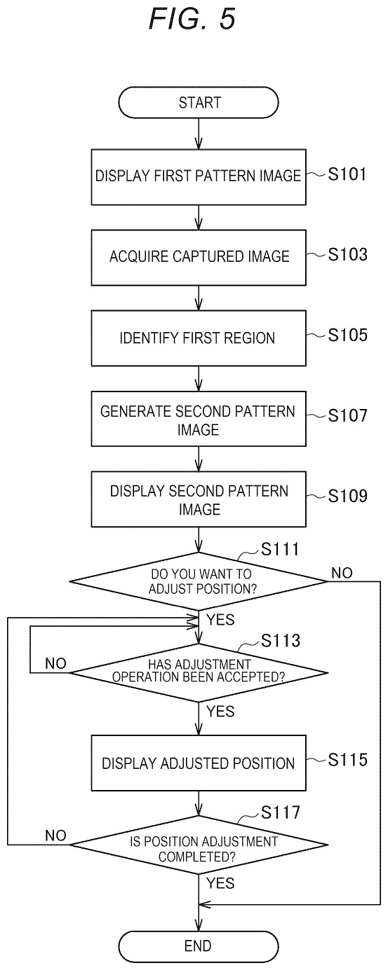

Processes carried out by the controller 150 will next be described with reference to FIG. 5. FIG. 5 is a flowchart showing an example of the processes carried out by the controller 150.

First, in the step S101, the first projection instruction section 151 projects and displays the first pattern image PT1 on the screen SC, as shown in FIG. 5.

Thereafter, in step S103, the acquisition section 152 causes the camera 160 to capture an image of the first pattern image PT1 projected onto the screen SC to acquire the captured image PD.

Thereafter, in step S105, the identification section 153 identifies the first region AR1, which is a region that fails to be normally detected out of the first pattern image PT1, in the captured image PD.

Thereafter, in step S107, the identification section 153 generates the second pattern image PT2, which is the first pattern image PT1 so processed that the first region AR1 of the first pattern image PT1 can be distinguished from a second region AR2. The second region AR2 is the region excluding the first region AR1 out of the first pattern image PT1. The identification section 153 causes the second pattern image PT2 to contain the inquiry image PQ. The inquiry image PQ is an image that inquires of the user whether to adjust the positions of the cross marks corresponding to the dot images DT contained in the first pattern image PT1 based on the user's operation.

Thereafter, in step S109, the second projection instruction section 154 projects and displays the second pattern image PT2 generated by the identification section 153 on the screen SC.

Thereafter, in step S111, the position adjustment section 155 determines whether to adjust the positions of the cross marks corresponding to the dot images DT contained in the first region AR1 in accordance with the user's operation.

When the position adjustment section 155 determines not to adjust the positions of the cross marks corresponding to the dot images DT contained in the first region AR1 in accordance with the user's operation (NO in step S111), the position adjustment section 155 then terminates the entire processes. When the position adjustment section 155 determines to adjust the positions of the cross marks corresponding to the dot images DT contained in the first region AR1 in accordance with the user's operation (YES in step S111), the position adjustment section 155 proceeds to the process in step S113.

Thereafter, in step S113, the position adjustment section 155 determines whether the operation of adjusting the positions of the cross marks corresponding to the dot images DT that fail to be normally detected in the corrected image generated by the image processing section 145 has been accepted. That is, in step S113, the corrected image containing the multiple cross marks is displayed in place of the second pattern image PT2. In the corrected image, the display mode (color, for example) of the cross marks corresponding to the dot images DT that fail to be normally detected differs from the display mode (color, for example) of the cross marks corresponding to the dot images DT that are normally detected.

When the position adjustment section 155 determines that the operation of adjusting the positions of the cross marks corresponding to the dot images DT has not been accepted (NO in step S113), the position adjustment section 155 enters a standby state in which no process is carried out. When the position adjustment section 155 determines that the operation of adjusting the positions of the cross marks corresponding to the dot images DT has been accepted (YES in step S113), the position adjustment section 155 proceeds to the process in step S115.

Thereafter, in step S115, the position adjustment section 155 adjusts and displays the positions of the cross marks corresponding to the dot images DT to the positions corresponding to the operation accepted in step S113.

Since the geometric correction has been normally performed on the cross marks in the second region AR2 of the corrected image based on the normally detected dot images DT, the cross marks contained in the second region AR2 are not moved in the present embodiment. The positions of the cross marks in the second region AR2 are therefore used as reference positions when the user manually adjusts the positions of the cross marks in the first region AR1.

Thereafter, in step S117, the position adjustment section 155 determines whether the adjustment of the positions of the cross marks corresponding to the dot images DT is completed based on the user's operation.

When the position adjustment section 155 determines that the adjustment of the positions of the cross marks corresponding to the dot images DT is not completed (NO in step S117), the position adjustment section 155 returns to the process in step S113. When the position adjustment section 155 determines that the adjustment of the positions of the cross marks corresponding to the dot images DT is completed (YES in step S117), the position adjustment section 155 terminates the entire processes.

Step S101 corresponds to an example of “displaying a first pattern image”. Step S103 corresponds to an example of “acquiring a captured image”. Step S105 corresponds to an example of “identifying a first region”. Step S109 corresponds to an example of “displaying a second pattern image”.

### Present Embodiment, and Effects and Advantages

As described above with reference to FIGS. 1 to 5, the display control method according to the present embodiment includes causing the projector 100 to project and display the first pattern image PT1 on the screen SC, causing the camera 160 to capture an image of the first pattern image PT1 to acquire the captured: image PD, identifying the first region AR1, which is a region that fails to be normally detected out of the first pattern image PT1, in the captured image PD, and causing the projector 100 to display the second pattern image PT2, which is the first pattern image PT1 so processed that the first region AR1 can be distinguished from the second region AR2, which is the region excluding the first region AR1 out of the first pattern image PT1.

That is, the projector 100 is caused to display the second pattern image PT2, which is the first pattern image PT1 so processed that the first region AR1 can be distinguished from the second region AR2, which is the region excluding the first region AR1 out of the first pattern image PT1. The first region AR1 is a region that fails to be normally detected out of the first pattern image PT1. The second region AR2 is the region excluding the first region AR1 out of the first pattern image PT1.

The user can therefore visually recognize the first region AR1, which is a region that fails to be normally detected. The failure in normal detection of the first pattern image PT1 contained in the first region AR1 can therefore be readily grasped.

Furthermore, in the display control method described above, causing the projector 100 to display the second pattern image PT2 causes the projector 100 to display the portion of the second pattern image PT2 that is contained in the first region AR1 in the first color C1, and causes the projector 100 to display the portion of the second pattern image PT2 that is contained in the second region AR2 in the second color C2 different from the first color C1.

Therefore, since the portion of the second pattern image PT2 that is contained in the first region AR1 is displayed in the first color C1 and the portion of the second pattern image PT2 that is contained in the second region AR2 is displayed in the second color C2 different from the first color C1, the user can readily visually recognize the first region AR1. The failure in normal detection of the first pattern image PT1 contained in the first region AR1 can therefore be readily grasped.

In the display control method described above, causing the projector 100 to display the second pattern image PT2 causes the projector 100 to display the second pattern image PT2 contained in the first region AR1 in a display mode according to a cause of the failure in the normal detection.

The user can therefore grasp the cause of the failure in the normal detection. The user's convenience can therefore be improved.

In the display control method described above, the second pattern image PT2 contains the inquiry image PQ, which inquires of the user whether to adjust the position of the adjustment point corresponding to the portion of the first pattern image PT1 in the first region AR1 based on the user's operation, and the display control method includes causing the projector 100 to display the second pattern image PT2 containing the inquiry image PQ, and adjusting the position of the adjustment point in accordance with the user's operation when an answer indicating that the position of the portion of the first pattern image PT1 in the first region AR1 is adjusted based on the user's operation is accepted from the projector 100.

The user can therefore determine whether to adjust the position of the portion of the first pattern image PT1 in the first region AR1 based on the user's operation. The user's convenience can therefore be improved. In addition, the position of the adjustment point corresponding to the portion of the first pattern image PT1 in the first region AR1 can be adjusted in accordance with the user's operation. The user's convenience can therefore be improved.

The display control method includes adjusting the position of the first pattern image PT1 contained in the first region AR1 based on the user's operation when the ratio of the first pattern image PT1 contained in the first region AR1 to the first pattern image PT1 is smaller than or equal to the threshold TH set in advance.

Therefore, for example, when the first pattern image PT1 contained in the first region AR1 falls within a range adjustable by the user's operation, the position of the first pattern image PT1 contained in the first region AR1 is adjusted based on the user's operation. The user's convenience can therefore be improved.

The control program PG according to the present embodiment causes the controller 150 of the projector 100 to carry out the processes including causing the projector 100 to project and display the first pattern image PT1 on the screen SC, causing the camera 160 to capture an image of the first pattern image PT1 to acquire the captured image PD, identifying the first region AR1, which is a region that fails to be normally detected out of the first pattern image PT1, based on the captured image PD, and causing a display apparatus including the projector 100 to display the second pattern image PT2, which is the first pattern image PT1 so processed that the first region AR1 can be distinguished from the second region AR2, which is a region excluding the first region AR1 out of the first pattern image PT1.

The control program PG according to the present embodiment can therefore provide the same advantages as the display control method according to the present embodiment.

The projector 100 according to the present embodiment projects and displays the first pattern image PT1 on the screen SC, causes the camera 160 to capture an image of the first pattern image PT1 to acquire the captured image PD, identifies the first region AR1, which is a region that fails to be normally detected out of the first pattern image PT1, based on the captured image PD, and projects and displays the second pattern image PT2 on the screen SC, the second pattern image PT2 being the first pattern image PT1 so processed that the first region AR1 can be distinguished from the second region AR2, which is a region excluding the first region AR1 out of the first pattern image PT1.

The projector 100 according to the present embodiment can therefore provide the same advantages as the display control method according to the present embodiment.

### Other Embodiments

The present embodiment described above is a preferable embodiment. The present disclosure is, however, not limited to the present embodiment described above, and the present embodiment can be changed in various manners to the extent that the changes do not depart from the gist of the present disclosure.

The present embodiment has been described with reference to, but not limited to, the case where the projector 100 includes the camera 160. The camera 160 may be disposed separately from the projector 100. For example, the camera 160 may be supported by a tripod and disposed to capture an image of the screen SC. In this case, the camera 160 and the projector 100 need to be communicably connected to each other.

The present embodiment has been described with reference to, but not limited to, the case where the “pattern images” are each multiple dot images DT arranged at equal intervals. The “pattern images” may each be a grid pattern image, a checkerboard pattern image, a phase shift pattern image, or the like. When the “pattern images” are each a phase shift pattern, a portion of the pattern image is pixels.

The present embodiment has been described with reference to, but not limited to, the case where the controller 150 of the projector 100 includes the first projection instruction section 151, the acquisition section 152, the identification section 153, the second projection instruction section 154, the position adjustment section 155, and the image storage section 156. For example, an information processing apparatus such as the personal computer 200, a tablet apparatus, or a smartphone may include the first projection instruction section 151, the acquisition section 152, the identification section 153, the second projection instruction section 154, the position adjustment section 155, and the image storage section 156. That is, the information processing apparatus may perform some or all of the functions performed by the controller 150 of the projector 100.

Furthermore, for example, when the information processing apparatus includes a camera like a smartphone, the camera of the smartphone may capture an image of the first pattern image PT1 in place of the camera 160 of the projector 100. In other words, the smartphone may execute the display control method according to the present embodiment.

The present embodiment has been described with reference to, but not limited to, the case where the “display apparatus” is the projector 100. The “display apparatus” may be a display apparatus different from the projector 100. The “display apparatus” may, for example, be a display such as a liquid crystal display (LCD) coupled to the personal computer 200.

The present embodiment has been described with reference to, but not limited to, the case where the controller 150 of the projector 100 causes the projector 100 to display the second pattern image PT2. The controller 150 of the projector 100 may transmit the second pattern image PT2 to a server apparatus.

In this case, multiple second pattern images PT2 in multiple projectors 100 can be stored in the server apparatus.

The present embodiment has been described with reference to, but not limited to, the case where the second pattern image PT2 contains the inquiry image PQ. For example, the second projection instruction section 154 may display the inquiry image PQ on the screen SC in the form of on-screen display (OSD). In this case, the YES button BY and the NO button BN are readily operated. Furthermore, in this case, the inquiry image PQ can be displayed in a region of the screen SC that differs from the region where the second pattern image PT2 is displayed. As a result, all the dot images DT contained in the second pattern image PT2 can be visually recognized.

The portions shown in FIGS. 1 and 2 represent functional configurations, and are not necessarily be implemented in a specific manner. That is, hardware corresponding to each of the functional portions is not necessarily implemented, and a single processor may execute a program to realize the functions of the multiple of functional portions. In the embodiment described above, some of the functions realized by software may be realized by hardware, or some of the functions realized by hardware may be realized by software. In addition, any changes can be made to the specific detailed configuration of each portion of the projector 100 to the extent that the changes do not depart from the intent of the present disclosure.

The process units in the flowchart shown in FIG. 5 are process units into which the processes carried out by the controller 150 of the projector 100 are divided in accordance with the contents of the primary processes to facilitate understanding of the processes. How to produce the divided process units or the names of the process units shown in the flowchart in FIG. 5 do not limit the present disclosure. A process carried out by the controller 150 may be further divided into a larger number of process units in accordance with the content of the process, and each of the process units may further be divided into a large number of processes. Furthermore, the order in which the processes are carried out in the flowchart described above is not limited to that shown in FIG. 5.

The “display control method” can be realized by causing the processor 150A provided in the projector 100 to execute the control program PG corresponding to the display control method. The control program PG can also be recorded in a computer readable recording medium.

The recording medium can be a magnetic or optical recording medium or a semiconductor memory device. Specific examples of the recording medium may include a flexible disk, an HDD, a CD-ROM (compact disk read only memory), a DVD, a Blu-ray (trademark registered) Disc, a magneto-optical disk, a flash memory, and a portable or immobile recording medium, such as a card-shaped recording medium. The recording medium may instead be a RAM, a ROM, an HDD, or any other nonvolatile storage apparatus that is an internal storage apparatus provided in the projector 100.

The display control method can also be realized by storing the control program PG in a server apparatus or the like and downloading the control program PG from the server apparatus to the projector 100.

### Additional Remarks

The present disclosure will be summarized below as additional remarks.

Additional Remark 1 A display control method including causing a projector to project a first pattern image onto a projection surface; causing a camera to capture an image of the first pattern image to acquire a captured image; identifying a first region that is a region that fails to be normally detected out of the first pattern image based on the captured image; and causing a display apparatus including the projector to display a second pattern image that is the first pattern image so processed that the first region is distinguishable from a second region that is a region excluding the first region out of the first pattern image.

The user can thus visually recognize the first region, which is a region that fails to be normally detected. The failure in the normal detection of the first pattern image contained in the first region can therefore be readily grasped.

Additional Remark 2 The display control method according to Additional Remark 1, wherein causing the display apparatus to display the second pattern image causes the display apparatus to display a portion of the second pattern image that is contained in the first region in a first color, and causes the display apparatus to display a portion of the second pattern image that is contained in the second region in a second color different from the first color.

The user can thus readily visually recognize the first region. The failure in the normal detection of the portion of the first pattern image that is contained in the first region can therefore be readily grasped.

Additional Remark 3 The display control method according to Additional Remark 1 or 2, wherein causing the display apparatus to display the second pattern image causes the display apparatus to display the second pattern image contained in the first region in a display mode according to a cause of the failure in the normal detection.

The user can thus grasp the cause of the failure in the normal detection. The user's convenience can therefore be improved.

Additional Remark 4 The display control method according to any one of Additional Remarks 1 to 3, wherein the second pattern image contains an inquiry image that inquires of a user whether to adjust a position of a portion of the first pattern image that is contained in the first region based on the user's operation, and the display control method further includes causing the display apparatus to display the second pattern image containing the inquiry image, and adjusting a position of an adjustment point corresponding to the portion of the first pattern image that is contained in the first region in accordance with the user's operation when an answer indicating that the position of the portion of the first pattern image is adjusted based on the user's operation is accepted from the display apparatus.

The user can therefore determine whether to adjust the position of the adjustment point corresponding to the portion of the first pattern image that is contained in the first region based on the user's operation. The user's convenience can therefore be improved. Furthermore, the position of the adjustment point corresponding to the portion of the first pattern image that is contained in the first region can be adjusted in accordance with the user's operation. The user's convenience can therefore be improved.

Additional Remark 5 The display control method according to any one of Additional Remarks 1 to 3, further including adjusting a position of the first pattern image contained in the first region based on a user's operation when a ratio of the first pattern image contained in the first region to the first pattern image is smaller than or equal to a threshold set in advance.

Therefore, for example, when the amount of the first pattern image contained in the first region falls within a range adjustable by the user's operation, the position of the first pattern image contained in the first region is adjusted based on the user's operation. The user's convenience can therefore be improved.

Additional Remark 6 A display control program causing a computer to carry out processes including causing a projector to project a first pattern image onto a projection surface; causing a camera to capture an image of the first pattern image to acquire a captured image; identifying a first region that is a region that fails to be normally detected out of the first pattern image based on the captured image; and causing a display apparatus including the projector to display a second pattern image that is the first pattern image so processed that the first region is distinguishable from a second region that is a region excluding the first region out of the first pattern image.

The display control program according to Additional Remark 6 thus provides the same advantages as the display control method according to Additional Remark 1.

Additional Remark 7 A projector configured to project a first pattern image onto a projection surface; cause a camera to capture an image of the first pattern image to acquire a captured image; identify a first region that is a region that fails to be normally detected out of the first pattern image based on the captured image; and project and display a second pattern image on the projection surface, the second pattern image being the first pattern image so processed that the first region is distinguishable from a second region that is a region excluding the first region out of the first pattern image.

The projector according to Additional Remark 7 thus provides the same advantages as the display control method according to Additional Remark 1.

What is claimed is:

1. A display control method comprising:
projecting, by a projector, a first pattern image onto a projection surface;
acquiring a captured image by capturing an image of the first pattern image with a camera;
identifying a first region that is a region that fails to be normally detected out of the first pattern image based on the captured image; and
displaying a second pattern image that is the first pattern image so processed that the first region is distinguishable from a second region that is a region excluding the first region out of the first pattern image.

2. The display control method according to claim 1, wherein
displaying the second pattern image includes
displaying a portion of the second pattern image that is contained in the first region in a first color, and
displaying a portion of the second pattern image that is contained in the second region in a second color different from the first color.

3. The display control method according to claim 1, wherein
displaying the second pattern image includes
displaying the second pattern image contained in the first region in a display mode according to a cause of the failure.

4. The display control method according to claim 1, wherein
the second pattern image contains an inquiry image that inquires of a user whether to adjust a position of a portion of the first pattern image that is contained in the first region based on the user's operation, and
the display control method further comprises adjusting a position of an adjustment point corresponding to the portion of the first pattern image in accordance with the user's operation when an answer indicating that the position of the portion of the first pattern image is adjusted based on the user's operation is accepted.

5. The display control method according to claim 1, further comprising
adjusting a position of the first pattern image contained in the first region based on a user's operation when a ratio of the first pattern image contained in the first region to the first pattern image is smaller than or equal to a threshold.

6. A display control program causing a computer to carry out processes including
projecting, by a projector, a first pattern image onto a projection surface;
acquiring a captured image by capturing an image of the first pattern image with a camera;
identifying a first region that is a region that fails to be normally detected out of the first pattern image based on the captured image; and
causing a display apparatus including the projector to display a second pattern image that is the first pattern image so processed that the first region is distinguishable from a second region that is a region excluding the first region out of the first pattern image.

7. A projector configured to
project a first pattern image onto a projection surface;
acquire a captured image by capturing an image of the first pattern image with a camera;
identify a first region that is a region that fails to be normally detected out of the first pattern image based on the captured image; and
project and display a second pattern image on the projection surface, the second pattern image being the first pattern image so processed that the first region is distinguishable from a second region that is a region excluding the first region out of the first pattern image.
